(19) United States
(12) Patent Application Publication
(10) Pub. No.: US 2012/0028625 A1
(43) Pub. Date: Feb. 2, 2012

(54) SYSTEM AND METHOD FOR GENERATING A MESSAGE NOTIFICATION BASED ON SENSORY DETECTION

(75) Inventor: Max Konig, Malmo (SE)

(73) Assignee: SONY ERICSSON MOBILE COMMUNICATIONS AB, SE-221 88 Lund (SE)

(21) Appl. No.: 13/132,491

(22) PCT Filed: Jun. 21, 2010
(86) PCT No.: PCT/IB2010/001495

§ 371 Date: Jun. 2, 2011

(51) Int. Cl. H04W 24/00

(52) U.S. Cl. 455/418; 455/456.3

(57) ABSTRACT

An electronic device (10) provides user message notifications as to messages that were received when the user was not in possession of or in the vicinity of the electronic device. The electronic device includes a communications circuit (46) for receiving an incoming message, and an output device (30, 32, 50) for outputting a message notification associated with the incoming message. A sensor (20) detects a user and generates a detection signal when the user is detected. A controller (41, 42) is configured to receive the detection signal, and configured in response to the detection signal to generate the message notification for outputting by the output device. In one embodiment, a timer (36) counts a predetermined time after receipt of the incoming message. If a user input is not received within the predetermined time, the controller causes the electronic device to enter an away from phone (AFP) mode in which the sensor is activated.

### TECHNICAL FIELD OF THE INVENTION

The present invention relates to a message notification system in a portable electronic device, and more particularly to a system and methods for generating a message notification based on a sensory detection.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

In particular, as a messaging device, a portable electronic device may have the capability to send and receive a variety of message types. For example, a portable electronic device may be configured to transmit, receive, and/or process text messages, often referred to as “SMS” (which stands for short message service) messages. The portable electronic device also may be configured to transmit, receive, and/or process electronic mail messages (emails), as well as multimedia messages (e.g., colloquially referred to by some as “an MMS,” which stands for multimedia message service), which may include text, image files, video files, audio files, and so forth. A portable electronic device also may receive “messages” in the form of alerts to alert the user of a device event. For example, a user may receive an alert of a missed call, of receipt of a voicemail message, receipt of a calendar event, and the like.

Regardless of the message type of a given message, when the message is received the portable electronic device may provide a relatively contemporaneous message notification to the user. Various notification types may be employed, either singly or in combination. For example, a user may receive an audible alert, such as a ringtone or the like, similar to an alert when a call is received. Another form of message notification may be a physical vibration, or a visual alert such as a lighted or blinking light emitting diode (LED) or comparable light emitting device. As stated above, message notifications may be used in combination relatively contemporaneously when the message or device event is received or occurs.

Such contemporaneous message notifications tend to be adequate when the user is in possession of the portable electronic device. There are times, however, when a user is not in physical possession of the portable electronic device, nor otherwise in the vicinity of the device. At such times, contemporaneous message notifications may not be recognized by the user. When the user gains physical possession of the portable electronic device after an extended period of absence, the user may not recognize that messages or device alerts have been received. A user, therefore, typically must actively and intentionally check for messages and alerts that may have been received while the user was not in physical possession of or in the vicinity of the device. If, for whatever reason, a user does not check for messages when physical possession is regained, it may be quite some time before the user recognizes that messages and/or alerts were received.

### SUMMARY

To improve the consumer experience with portable electronic devices, there is a need in the art for an improved system and method for generating a message notification, particularly after a period in which a user did not have physical possession of the portable electronic device. The present invention provides a system and methods for generating a message notification based on a sensory detection. For example, when the user obtains possession or returns to the vicinity of the electronic device, a sensor may detect the presence of the user and generate a detection signal. In response to the detection signal, a message notification may be outputted. In this manner, a user is effectively notified that a message or device alert was received when the user was not in possession of or in the vicinity of the electronic device.

Therefore, according to one aspect of the invention, an electronic device includes a communications circuit for receiving an incoming message, and an output device for outputting a message notification associated with the incoming message, and a sensor for detecting a user and generating a detection signal when the user is detected. A controller is configured to receive the detection signal, and configured in response to the detection signal to generate the message notification for outputting by the output device.

According to one embodiment of the electronic device, the electronic device further includes a timer that counts a first predetermined time after receipt of the incoming message. If a detection signal is not received within the first predetermined time, the controller is configured to cause the electronic device to enter an away from phone (AFP) mode. If a detection signal is received during the AFP mode, the controller is configured in response to the detection signal to generate the message notification for outputting by the output device.

According to one embodiment of the electronic device, the electronic device further includes an input device for receiving a user input to access the message, and a timer that counts a first predetermined time after receipt of the incoming message. If the user input is not received within the first predetermined time, the controller is configured to cause the electronic device to enter an away from phone (AFP) mode.

According to one embodiment of the electronic device, the controller is configured to activate the sensor when the AFP mode is entered.

According to one embodiment of the electronic device, in response to generating the message notification, the timer is configured to count a second predetermined time.

According to one embodiment of the electronic device, when a user input is not received by the input device within the second predetermined time, the controller is configured to cause the electronic device to exit AFP mode.

According to one embodiment of the electronic device, when a user input is not received by the input device within the second predetermined time, the controller is configured to generate the message notification a predetermined number of instances, and after cause the electronic device to exit AFP mode.

According to one embodiment of the electronic device, the sensor includes an accelerometer for detecting when the electronic device has been moved by the user.

According to one embodiment of the electronic device, the sensor includes at least one of a motion detector for detecting motion of the user in the vicinity of the electronic device, or an optical sensor for sensing the presence of the user.

According to one embodiment of the electronic device, the output device includes a speaker, and the message notification is an audible notification through the speaker.

According to one embodiment of the electronic device, the output device includes a vibration generator, and the message notification is a physical vibration.

According to one embodiment of the electronic device, the output device includes a light emitting device, and the message notification is a light output from the light emitting device.

According to one embodiment of the electronic device, the electronic device is a mobile telephone.

Another aspect of the invention is a method for generating a message notification in an electronic device. The method includes the steps of receiving an incoming message to the electronic device, detecting a user and generating a detection signal when the user is detected, in response to the detection signal, generating the message notification, and outputting the message notification associated with the incoming message.

According to one embodiment of the method, the method further includes starting a timer that counts a first predetermined time after receipt of the incoming message, and determining whether a detection signal has been generated within the first predetermined time. If it is determined that the detection signal is not generated within the first predetermined time, the method includes entering an away from phone (AFP) mode, wherein entering the AFP comprises activating a sensor (20) to detect the user.

According to one embodiment of the method, the method further includes starting a timer that counts a first predetermined time after receipt of the incoming message, and determining whether a user input has been received to access the message within the first predetermined time. If it is determined that the user input is not received within the first predetermined time, the method includes entering an away from phone (AFP) mode, wherein entering the AFP comprises activating a sensor to detect the user.

According to one embodiment of the method, the method further includes, in response to generating the message notification, starting the timer to count a second predetermined time.

According to one embodiment of the method, the method further includes determining whether a user input has been received within the second predetermined time, and if it is determined that a user input is not received within the second predetermined time, exiting the AFP mode.

According to one embodiment of the method, the method further includes determining whether a user input has been received within the second predetermined time, and if it is determined that a user input is not received within the second predetermined time, generating the message notification a predetermined number of instances, and after exiting the AFP mode.

Another aspect of the invention is a system for generating a message notification that includes a first electronic device and a second electronic device. The first electronic device includes a first communications circuit for receiving an incoming message and for outputting a received message signal. The second electronic device includes a second communications circuit for receiving the received message signal, an output device for outputting a message notification associated with the incoming message, and a sensor for detecting a user and generating a detection signal when the user is detected. A controller of the second electronic device is configured to receive the detection signal, and configured in response to the detection signal to generate the message notification for outputting by the output device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic front view of a mobile telephone as an exemplary electronic device for use in accordance with an embodiment of the present invention.

FIG. 2 is a schematic rear view of a mobile telephone as an exemplary electronic device for use in accordance with an embodiment of the present invention.

FIG. 3 is a schematic block diagram of operative portions of the mobile telephone of FIGS. 1 and 2.

FIG. 4 is a schematic diagram of a communications system in which the mobile telephone of FIGS. 1 and 2 may operate.

FIG. 5 is a flowchart depicting an overview of an exemplary method for generating a message notification based on a sensory detection.

FIG. 6 is a flowchart depicting a second exemplary method for generating a message notification based on a sensory detection.

FIG. 7 is a schematic diagram of an exemplary system for generating a message notification including two electronic devices communicating over a network.

### DETAILED DESCRIPTION OF EMBODIMENTS

The present invention provides a system and methods for generating a message notification based on a sensory detection. Such system and methods are suitable for notifying a user that a message or device alert was received during a time period when the user was not in physical possession of the portable electronic device. Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a laptop or other portable computing device. For purposes of the description herein, the interchangeable terms “electronic equipment” and “electronic device” also may include portable radio communication equipment. The term “portable radio communication equipment,” which sometimes is referred to as a “mobile radio terminal,” includes all equipment such as mobile telephones, pagers, communicators, electronic organizers, personal digital assistants (PDAs), smartphones, and any communication apparatus or the like.

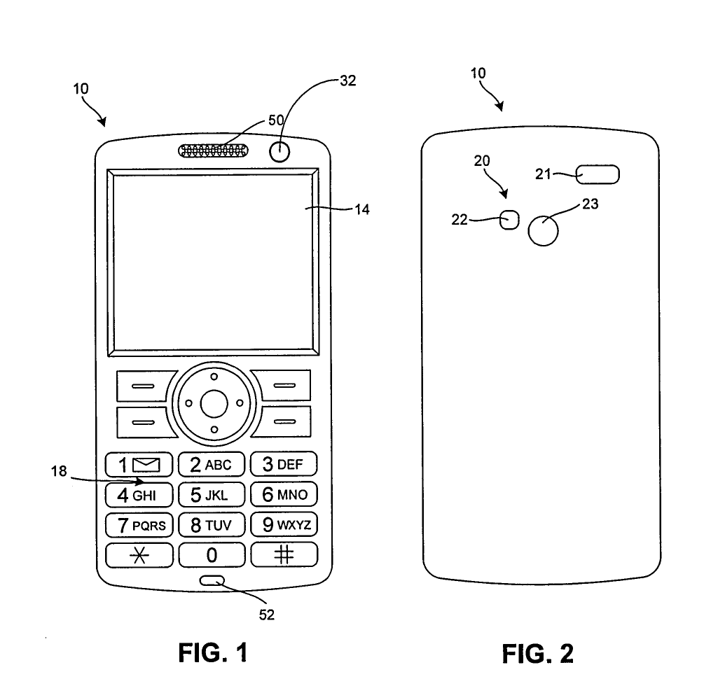

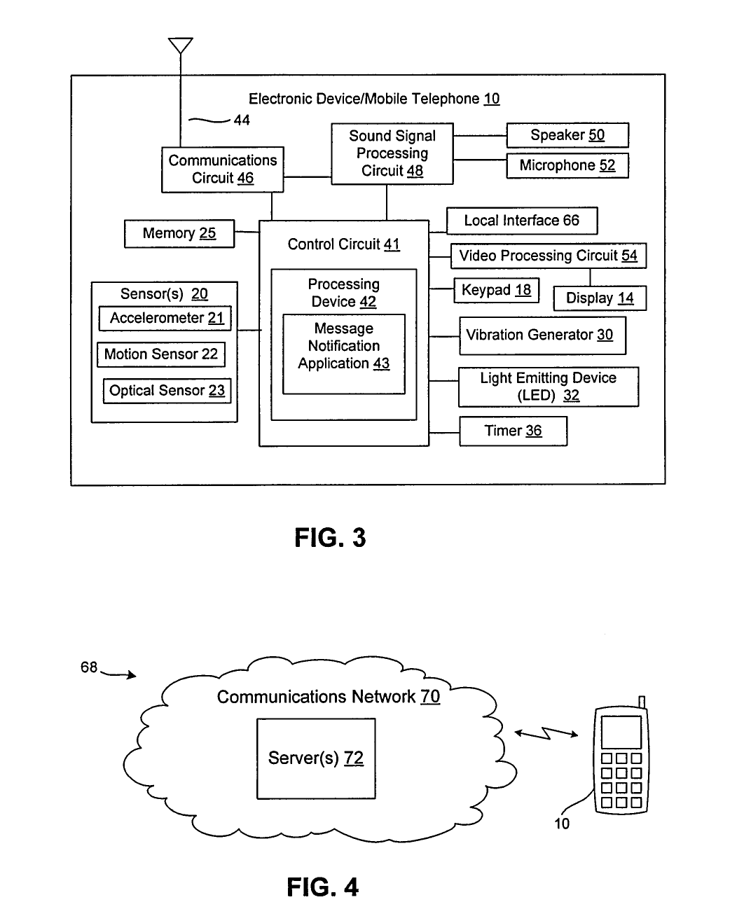

FIG. 1 is a schematic front view of an electronic device 10 in the form of a mobile telephone, and FIG. 2 is a schematic back view of the electronic device/mobile telephone 10. FIG. 3 is a schematic block diagram of operative portions of the electronic device/mobile telephone 10. The exemplary mobile telephone is depicted as having a “block” or “brick” configuration, although the mobile telephone may have other configurations, such as, for example, a clamshell, pivot, swivel, and/or sliding cover configuration as are known in the art.

Referring to FIG. 3, the mobile telephone 10 may include a primary control circuit 41 that is configured to carry out overall control of the functions and operations of the mobile telephone 10. The control circuit 41 may include a processing device 42, such as a CPU, microcontroller or microprocessor.

Among their functions, to implement the features of the present invention, the control circuit 41 and/or processing device 42 may comprise a controller that may execute program code stored on a machine-readable medium embodied as the message notification application 43. Application 43 may be a stand-alone software application or form a part of a software application that carries out additional tasks related to the mobile telephone 10. It will be apparent to a person having ordinary skill in the art of computer programming, and specifically in application programming for mobile telephones, servers or other electronic devices, how to program a mobile telephone to operate and carry out logical functions associated with the message notification application 43. Accordingly, details as to specific programming code have been left out for the sake of brevity. Also, while the code may be executed by control circuit 41 in accordance with exemplary embodiments, such controller functionality could also be carried out via dedicated hardware, firmware, software, or combinations thereof, without departing from the scope of the invention.

The mobile telephone 10 may include an antenna 44 coupled to a communications circuit 46. The communications circuit 46 may include call circuitry that enables the mobile telephone 10 to establish a call and/or exchange signals with a called/calling device, typically another mobile telephone or landline telephone, or another electronic device. The communications circuit 46 also may be configured to transmit, receive, and/or process data such as text messages, often referred to as “SMS” (which stands for short message service) messages. The communications circuit 46 also may be configured to transmit, receive, and/or process electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 25, executing applications to allow user interaction with data, displaying video and/or image content associated with the data, outputting audio sounds associated with the data and so forth.

The mobile telephone 10 further includes a sound signal processing circuit 48 for processing audio signals transmitted by and received from the communications circuit 46. Coupled to the sound processing circuit 48 are a speaker 50 and microphone 52 that enable a user to listen and speak via the mobile telephone 10 as is conventional.

Referring to FIGS. 2 and 3, the electronic device 10 may include one or more sensors 20. As further explained below, the sensors 20 may be employed to detect the presence of a user, such as when the user regains or intends to regain physical possession of the electronic device 10 following a period of absence. For example, one of the sensors 20 may be an accelerometer 21 that detects motion of the electronic device itself, such as when the user picks up the device to regain physical possession of the device. As another example, one of the sensors 20 may be a motion sensor 22 that may detect motion of a user in the vicinity of the electronic device 10. For example, the motion sensor may emit an infrared (IR) or similar beam, which when broken by motion generates a motion detection signal. As another example, one of the sensors 20 may be an optical sensor 23. The optical sensor may detect an image or object in the vicinity of the electronic device 10. The optical sensor may be employed as part of a camera assembly (not shown) that may be used to generate still images and/or video. The motion sensor 22 or optical sensor 23 may detect when a user is in the vicinity of the electronic device 10, such as, for example, when the user approaches the electronic device to regain physical possession of the electronic device.

Accelerometers, motion detectors, and optical sensors are known in the art and may be provided with any configuration suitable for incorporation and use in a portable electronic device. In addition, other sensor types may be employed to detect motion of the portable electronic device, or the presence of a user in the vicinity of the portable electronic device, to detect when a user has regained or likely intends to regain physical position of the portable electronic device. Furthermore, FIG. 2 depicts the sensors 20 as being located on the back face of the portable electronic device. Sensors may be located at additional or alternative placement locations on or within the portable electronic device. For example, sensors may be located on the front face and/or sides of the portable electronic device in addition or alternatively to locating sensors on the back face of the portable electronic device. Certain sensor types, such as an accelerometer for example, may be positioned internally without being visible to the user as depicted in FIG. 2. It will be appreciated, therefore, that sensor type, number, component configuration, and/or placement on the portable electronic device may be varied.

Referring to FIG. 4, the portable electronic device/mobile telephone 10 may be configured to operate as part of a communications system 68. The system 68 may include a communications network 70 having a server 72 (or servers) for managing calls placed by and destined to the mobile telephone 10, transmitting messages and data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software. The network 70 may be employed by numerous users to transmit and share previously generated routes between and among participant devices.

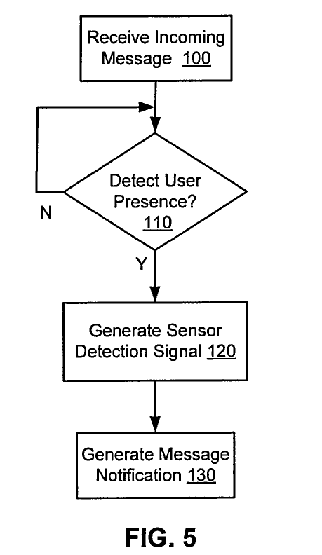

FIG. 5 is a flowchart depicting an overview of an exemplary method for generating a message notification based on a sensory detection. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 5, at step 100 the electronic device may receive an incoming message. The message may be any type of message, such as, for example an SMS message, MMS message, email, or others. The message also may be a device alert message, such as, for example, a missed call alert, an alert indicating the receipt of a voicemail, a calendar event alert, or others. It will be appreciated the precise type of message may vary.

At step 110, a determination may be made as to whether the user has been detected by one or more of the sensors described above. If the user is not detected, the sensors will continue to operate to attempt to detect the user's presence.

If at step 110 the user's presence is detected, at step 120 the electronic device may generate a sensor detection signal based on an action or presence of the user. For example, the accelerometer 21 in the electronic device may detect motion of the electronic device, such as when the user has picked up or moved the electronic device. Alternatively or additionally, the motion sensor 22 in the electronic device may detect the motion of the user when the user moves in the vicinity of electronic device. Alternatively or additionally, the optical sensor 23 may detect the presence of the user in the vicinity of the electronic device. Regardless of the type of sensor, a sensor detection signal may be generated to indicate a corresponding action or presence of the user.

At step 130, in response to the sensor detection signal, the electronic device may generate a message notification through an output device. For example, a controller in the electronic device (such as control circuit 41 and or processing device 42), may receive the sensor detection signal and generate the message notification to be outputted through the output device. The message notification may be an audible, physical, or visual alert, and combinations thereof. A variety of output devices may be employed for outputting different types of message notifications. For example, the controller may cause the output of an audible alert, such as a ringtone or similar alert through an output device in the form of the speaker 50 of the electronic device (see FIGS. 1 and 3). As another example, the controller may cause the output of a physical alert through an output device in the form of vibrations of a vibration generator 30 of the electronic device (see FIG. 3). As another example, the controller may cause the output of a visual alert through an output device in the form of an activation or blinking of a light emitting device 32 of the electronic device (see FIGS. 1 and 3), such as a light emitting diode (LED). It will be appreciated, therefore, that the notification message may be any of various audible, physical, and visual alerts or signals commonly outputted by electronic devices, and combinations thereof.

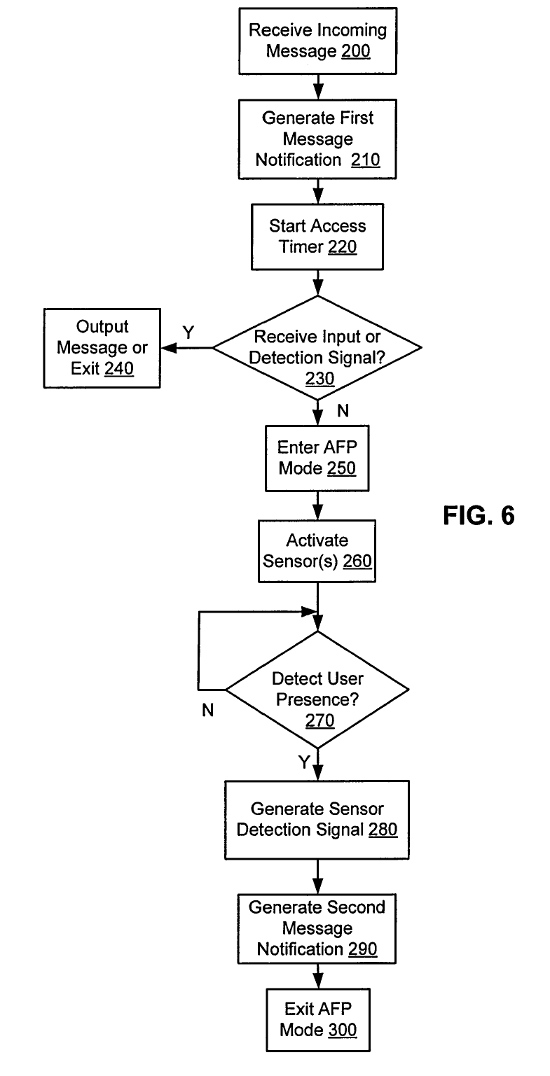

The method of FIG. 5 provides a general overview of the message alert system. The above general overview may be varied to account for specific circumstances of use. FIG. 6 is a flowchart depicting a second exemplary method for generating a message notification based on a sensory detection. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 6, at step 200 the electronic device may receive an incoming message. As stated above, the message may be any type of message, such as, for example an incoming SMS message, MMS message, email, or others. The message also may be a device alert message, such as, for example, a received or missed call alert, an alert indicating the receipt of a voicemail, a calendar event alert, or others. It will be appreciated the precise type of message may vary. At this stage of this particular embodiment, it is not yet determined by the device whether the user is in the vicinity of the electronic device or not.

At step 210, a first message notification may be generated. As is conventional, the receipt of an incoming message or device alert may generate any of various audible alerts or ringtones, physical alerts such as a vibration, visual alerts such as an LED indicator, or combinations thereof. The user may be in possession of, or in the vicinity of, the electronic device. Circumstances, therefore, may permit the user to access the message or alert substantially contemporaneously or close in time to receipt of the incoming message. It is desirable to afford the user an opportunity to access a message or alert in the ordinary course.

To address such circumstances, the electronic device 10 may include an access timer 36 (see FIG. 3) to aid in determining whether the user accesses a message within a predetermined time after receipt. Referring again to FIG. 6, at step 220, after the first message notification is generated, the access timer may be started. The access timer may count a first predetermined time for a user to access the message after the message is received. The first predetermined time may be any suitable time for affording the user a reasonable opportunity to respond to a message alert when the electronic device is within the user's possession or vicinity. For example, the first predetermined time of the access timer may be thirty seconds, one minute, two minutes, five minutes, or other suitable time period, after the message or alert is received and the first message notification is generated.

In addition, a user may be in possession of or in the vicinity the mobile telephone, but simply not wish to answer the first notification message. For example, the user may not wish to be disturbed. It is desirable, therefore, to detect the user so as to avoid generating additional message notifications. Furthermore, certain messages or alerts may be accessed by a user without necessitating an actual user input. For example, some alerts may be accessed by a user simply by picking up and looking at the phone. It is desirable, therefore, to detect such situations as well.

At step 230, therefore, a determination is made as to whether the electronic device has received a user input by which the user accesses the message or alert within the first predetermined time of the timer 36. For example, the user may access a received message by employing a keypad input by keypad 18, a touchscreen input on a display 14, voice command, or by any suitable input means. In addition, a determination may be made as to whether a detection signal is received. As stated above, if the presence of the user is detected in absence of a user input to access the message, the user may not wish to be disturbed. Alternatively, the user may access a given message or alert without providing an additional user input. In such cases, a detection signal still may be generated by one of the sensors 20.

If at step 230 a user input is received to access the message, at step 240 the message is outputted. The electronic device may output the message by any suitable means. For example, a visual message may be displayed on the display 14, or an audible message may be outputted through the speaker 50. Messages having both audible and visual components may be outputted in a combined fashion using the display and speaker. If a detection signal is received indicating the user is present but not otherwise providing a user input, the method may simply exit insofar as the user may not wish to be disturbed or has accessed the message without providing an additional input.

If at step 230, however, a message access input or detection signal is not received, the electronic device may presume the user is not in possession of or in the vicinity of the electronic device. In accordance with such circumstances, at step 250 the electronic device may enter an “away from phone” (AFP) mode. For example, the controller 41, 42 of the electronic device may cause the electronic device to enter the AFP mode. Entering the AFP mode includes activating the features of the electronic device pertaining to the handling of messages and alerts received when the user is not in possession of or in the vicinity of the electronic device. In particular, entering the AFP mode may include activating one or more of the sensors 20. Accordingly, at step 260 the electronic device may activate one or more of the sensors 20. As stated above, the sensors 20 may be one or more of any suitable sensors for detecting the presence or action of the user. For example, the sensors 20 may include one or more of the accelerometer 21 that detects motion of the electronic device itself, the motion sensor 22 that may detect motion of a user in the vicinity of the electronic device, the optical sensor that may detect the presence of an object in the vicinity of the electronic device, or others.

At step 270, a determination is made as to whether the user has been detected by one or more of the sensors. If the user's presence is not detected, the sensors will continue to operate to attempt to detect the user. If at step 270 the user is detected, at step 280 a detection signal may be generated by the one or more sensors that have detected the user. For example, the accelerometer 21 in the electronic device may detect motion of the electronic device, such as when the user has picked up or moved the electronic device. Alternatively or additionally, the motion sensor 22 in the electronic device may detect the motion of the user when the user moves in the vicinity of electronic device. Alternatively or additionally, the optical sensor 23 may detect the presence of the user in the vicinity of the electronic device. Regardless of the type of sensor, a sensor detection signal may be generated to indicate a corresponding action or presence of the user.

At step 290, in response to the sensor detection signal, the electronic device may generate a second message notification. For example, similarly as described above, the controller in the electronic device (such as control circuit 41 and or processing device 42), may receive the sensor detection signal and generate the message notification. The message notification may be an audible, physical, or visual alert, and combinations thereof outputted through an output device. For example, the controller may cause the output of an audible alert, such as a ringtone or similar alert, through the speaker 50 of the electronic device (see FIGS. 1 and 3). As another example, the controller may cause the output of a physical alert in the form of vibrations of the vibration generator 30 of the electronic device (see FIG. 3). As another example, the controller may cause the output of a visual alert, such as the activation or blinking of the light emitting device 32 of the electronic device (see FIGS. 1 and 3), such as a light emitting diode (LED). It will be appreciated, therefore, that the notification message may be any of various audible, physical, and visual alerts or signals commonly outputted by electronic devices, and combinations thereof.

Following generation of the second notification message, at step 300 the electronic device may exit the AFP mode. For example, the controller (41, 42) may cause the electronic device to exit the AFP mode. Exiting the AFP mode may reduce the level of interruption that otherwise may occur. For example, having been detected and notified of the presence of messages or alerts, the user may not want to be continually detected and notified again. By limiting the second message notification to a single instance, the electronic device may avoid unnecessarily issuing additional message notifications, which may be disruptive to the user.

As an alternative, the second message notification need not be limited to a single instance, but may include a suitable predetermined number of instances. For example, the second message notification may be generated in two, three, or other number of instances to ensure the second notification is recognized. The subsequent instances may be based upon additional detection signals, or based upon a predetermined set time measured from the first instance of the generation of the second message notification. For example, the timer 36 may count a second predetermined time measured from the generation of the first instance of the second message notification. The second predetermined time may provide a basis upon which AFP mode is exited. Alternatively, the second predetermined time may provide a basis for subsequent generations of the message notification for a predetermined number of instances. Once the second message notification has been generated for the predetermined number of instances, the AFP mode may be exited. In this manner, the system provides a substantial likelihood the user will be notified that messages or alerts have been received, with minimal unnecessary interruption.

In another embodiment, the AFP mode may be disabled and enabled by a user input. The user input may be provided with the keypad 18 or by any other suitable means. For example, the user may be in a situation, such as in a meeting, social event, or the like, in which the user simply does not want to be disturbed. The user, therefore, may intentionally not respond to received messages, and also would not want the AFP mode to be activated. Accordingly, the user may disable the AFP mode. The user may enable the AFP mode again when the user enters a situation in which the user would want to be notified of the messages and alerts.

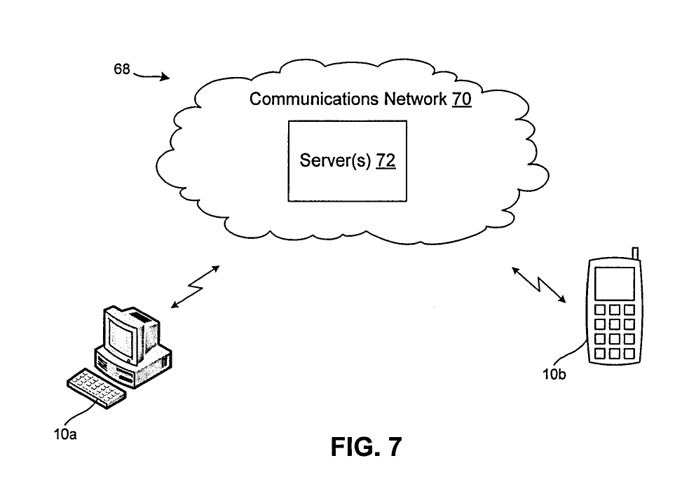

In an alternative embodiment, the electronic device that received the message need not be the same electronic device as the device that generates the message notification. FIG. 7 depicts an exemplary system for generating a message notification including two electronic devices 10a and 10b communicating over the network 68. The first electronic 10a may include communications circuitry for receiving an incoming message and for outputting a received message signal. In FIG. 7, the device 10a is depicted as computer. The device 10a may be any suitable electronic device, and may be another portable electronic device.

The second electronic device 10b is depicted as being a mobile telephone, although the second electronic device 10b also may be any suitable electronic device. The second electronic device may include communications circuitry for receiving the received message signal, and an output device for outputting a message notification associated with the incoming message to device 10a. The second electronic device 10b includes a sensor for detecting a user and generating a detection signal when the user is detected, and a controller configured to receive the detection signal. The controller may be configured, in response to the detection signal, to generate the message notification for outputting by the output device. In this manner, the second electronic device 10b provides a message notification to the user that a message has been received by the first electronic device 10a. It will be appreciated that the sensors, message type, output devices, and other features described above may be utilized in the system of FIG. 7 employing two electronic devices communicating over a network.

Referring again to FIGS. 1 and 3, additional features of the mobile telephone 10 will now be described. For the sake of brevity, generally conventional features of the mobile telephone 10 will not be described in great detail herein.

As stated above, the mobile telephone 10 has a display 14 that displays information to a user regarding the various features and operating state of the mobile telephone 10, and displays visual content received by the mobile telephone 10 and/or retrieved from the memory 25.

The keypad 18 referenced previously provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. The special function keys may also include various keys for navigation and selection operations to access menu information within the mobile telephone 10. As shown in FIG. 1, for example, the special function keys may include a five-way navigational ring containing four directional surfaces and a center button that may be used as an “enter key” selection button. Some or all of the keys may be used in conjunction with the display as soft keys. Keys or key-like functionality also may be embodied as a touch screen associated with the display 14.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 25, derived from an incoming video data stream received by the communication circuit 46, or obtained by any other suitable method.

The mobile telephone 10 also may include a local interface 66, such as an infrared transceiver and/or an RF adaptor (e.g., a Bluetooth adapter), for establishing communication with an accessory, another mobile radio terminal, a computer or another device. For example, the local interface 66 may include a wireless interface that operatively couples the mobile telephone 10 to a headset assembly (e.g., a PHF device) in an embodiment where the headset assembly has a corresponding wireless interface. The local interface of the telephone 10 also may permit connection to a variety of I/O conventional I/O devices. Examples may include a wired or wireless connection to external print, camera, and other accessory devices, and/or to a power charger that can be used to charge an internal power supply unit (PSU).

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. An electronic device comprising:
a communications circuit for receiving an incoming message;
an output device for outputting a message notification associated with the incoming message;
a sensor for detecting a user and generating a detection signal when the user is detected; and
a controller configured to receive the detection signal, and configured in response to the detection signal to generate the message notification for outputting by the output device.

2. The electronic device according to claim 1, further comprising:
a timer that counts a first predetermined time after receipt of the incoming message;
wherein if a detection signal is not received within the first predetermined time, the controller is configured to cause the electronic device to enter an away from phone (AFP) mode; and
wherein if a detection signal is received during the AFP mode, the controller is configured in response to the detection signal to generate the message notification for outputting by the output device.

3. The electronic device according to claim 1, further comprising:
an input device for receiving a user input to access the message; and
a timer that counts a first predetermined time after receipt of the incoming message;
wherein if the user input is not received within the first predetermined time, the controller is configured to cause the electronic device to enter an away from phone (AFP) mode.

4. The electronic device according to claim 2, wherein the controller is configured to activate the sensor when the AFP mode is entered.

5. The electronic device according to claim 4, wherein in response to generating the message notification, the timer is configured to count a second predetermined time.

6. The electronic device according to claim 5, wherein when a user input is not received by the input device within the second predetermined time, the controller is configured to cause the electronic device to exit AFP mode.

7. The electronic device according to claim 5, wherein when a user input is not received by the input device within the second predetermined time, the controller is configured to generate the message notification a predetermined number of instances, and after cause the electronic device to exit AFP mode.

8. The electronic device according to claim 1, wherein the sensor comprises an accelerometer for detecting when the electronic device has been moved by the user.

9. The electronic device according to claim 1, wherein the sensor comprises at least one of a motion detector for detecting motion of the user in the vicinity of the electronic device, or an optical sensor for sensing the presence of the user.

10. The electronic device according to claim 1, wherein the output device comprises a speaker, and the message notification is an audible notification through the speaker.

11. The electronic device according to claim 1, wherein the output device comprises a vibration generator, and the message notification is a physical vibration.

12. The electronic device according to claim 1, wherein the output device comprises a light emitting device, and the message notification is a light output from the light emitting device.

13. The electronic device according to of claim 1, wherein the electronic device is a mobile telephone.

14. A method for generating a message notification in an electronic device comprising the steps of:
receiving an incoming message to the electronic device;
detecting a user and generating a detection signal when the user is detected;
in response to the detection signal, generating the message notification; and
outputting the message notification associated with the incoming message.

15. The method for generating a message notification according to claim 14, further comprising:
starting a timer that counts a first predetermined time after receipt of the incoming message;
determining whether a detection signal has been generated within the first predetermined time; and
if it is determined that the detection signal is not generated within the first predetermined time, entering an away from phone (AFP) mode, wherein entering the AFP comprises activating a sensor to detect the user.

16. The method for generating a message notification according to claim 14, further comprising:
starting a timer that counts a first predetermined time after receipt of the incoming message;
determining whether a user input has been received to access the message within the first predetermined time; and
if it is determined that the user input is not received within the first predetermined time, entering an away from phone (AFP) mode, wherein entering the AFP comprises activating a sensor to detect the user.

17. The method for generating a message notification according to claim 15, further comprising in response to generating the message notification, starting the timer to count a second predetermined time.

18. The method for generating a message notification according to claim 17, further comprising:
determining whether a user input has been received within the second predetermined time; and
if it is determined that a user input is not received within the second predetermined time, exiting the AFP mode.

19. The method for generating a message notification according to claim 17, further comprising:
determining whether a user input has been received within the second predetermined time; and
if it is determined that a user input is not received within the second predetermined time, generating the message notification a predetermined number of instances, and after exiting the AFP mode.

20. A system for generating a message notification comprising:
a first electronic device comprising a first communications circuit for receiving an incoming message and for outputting a received message signal; and
a second electronic device comprising a second communications circuit for receiving the received message signal, an output device for outputting a message notification associated with the incoming message, a sensor for detecting a user and generating a detection signal when the user is detected, and a controller configured to receive the detection signal, and configured in response to the detection signal to generate the message notification for outputting by the output device.
